(19) United States
(12) Patent Application Publication
(10) Pub. No.: US 2016/0040644 A1
(43) Pub. Date: Feb. 11, 2016

(54) ENGINE WITH LASER IGNITION

(71) Applicant: Ford Global Technologies, LLC, Dearborn, MI (US)

(72) Inventors: Douglas Raymond Martin, Canton, MI (US); Kenneth James Miller, Canton, MI (US)

(21) Appl. No.: 14/920,694

(22) Filed: Oct. 22, 2015

Related U.S. Application Data
(63) Continuation-in-part of application No. 13/677,641, filed on Nov. 15, 2012.

(51) Int. Cl. F02P 23/04; F02P 5/04; F02P 17/02

(52) U.S. Cl. CPC F02P 23/04; F02P 17/02; F02P 5/045

(57) ABSTRACT

Systems and methods for increasing an accuracy of misfire detection are described. An infra-red sensor coupled to a cylinder is used to sense an in-cylinder temperature profile following a laser ignition event. A misfire event is identified based on a deviation of the sensed profile from an expected profile.

### CROSS REFERENCE TO RELATED APPLICATION

The present application is a continuation-in-part of U.S. patent application Ser. No. 13/677,641, entitled “LASER IGNITION AND MISFIRE MONITOR,” filed Nov. 15, 2012, the entire contents of which are hereby incorporated by reference for all purposes.

### BACKGROUND AND SUMMARY

On hybrid electric vehicles (HEV) and stop-start vehicles, an internal combustion engine (ICE) may shut-down or deactivate during selected conditions. Shutting down the engine may save fuel by avoiding certain conditions, such as idling conditions, for example. During a restart of the engine, a position of the engine cams/pistons may be determined so that sequential and accurate fueling, and spark timing, may be provided to obtain reliable low emissions starts.

Engine control systems may also include misfire detection modules for identifying combustion events that occur outside of a base ignition timing. As one example, misfires may be detected using RPM-based methods wherein torque pulses are correlated with crankshaft speed. As another example, misfires may be detected based on exhaust pressure wherein exhaust pressure pulses are correlated with crankshaft speed.

The inventors herein have recognized that such misfire approaches may have limitations. For example, RPM-based methods may be inefficient at high RPMs, particularly with high cylinder count engines. This is because in engines with a high cylinder count, each individual ignition event covers a smaller arc of the engine rotation before the next event takes place. Consequently, even a single misfire event in a high cylinder count engine may be muted by the next ignition event occurring much sooner during the rotation of the engine. For example, a 1-cylinder engine may have a higher deceleration from a single misfire event, losing a higher percentage of it's rotation speed before the next firing. In comparison, a 12-cylinder engine may have almost have no perceptive change in RPM from a single misfire event.

As another example, exhaust pressure based methods require the presence of pressure transducers in the exhaust system. The additional hardware adds component cost and complexity. In addition, the location of the hardware in the severe environment of the exhaust system can lead to warranty issues. Further still, the approaches discussed above monitor effects resulting from the misfire, rather than monitoring the misfire itself. Consequently, such approaches may cause inaccurate misfire detection under non-ideal vehicle operating conditions. For example, RPM-based methods may inaccurately identify misfires when the vehicle is travelling on rough roads. As another example, exhaust pressure-based methods may inaccurately identify misfires when there is frozen condensation in the sensor line.

In one example, some of the above issues may be addressed by a method for an engine comprising: igniting air-fuel mixture in an engine cylinder with a laser ignition device and indicating a misfire based on an infrared sensor coupled to the cylinder. In this way, hardware available in an engine configured with a laser ignition system can be advantageously used to accurately identify engine misfire events.

As one example, a laser ignition device may be operated to ignite an air-fuel mixture in an engine cylinder. After a threshold duration since the ignition has elapsed, an in-cylinder temperature profile may be estimated by an infrared sensor coupled to the engine. In particular, heat produced during a cylinder combustion event may be sensed by the infrared sensor. If the temperature profile corresponds to a combustion profile, it may be determined that no misfire has occurred. However, if the temperature profile does not correspond to combustion, a misfire may be determined. For example, if the peak in-cylinder temperature of the temperature profile is below a threshold temperature (e.g., below a peak combustion temperature), a misfire may be determined. As another example, if the peak in-cylinder temperature occurs outside of a threshold duration since the laser ignition (e.g., later than expected), a misfire may be determined.

In this way, it may be possible to take advantage of a laser ignition system to increase an accuracy of misfire detection. For example, such an approach may provide faster and more accurate information on when cylinder combustion occurred. By correlating cylinder information gathered by an infrared sensor with the timing of a laser ignition event, incomplete combustion due to a misfire can be identified. Accordingly, appropriate mitigating actions may be taken.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF DRAWINGS

FIG. 1 shows an example internal combustion engine.

FIG. 2 shows a high level flow chart of a method for identifying a cylinder misfire event based on an in-cylinder temperature profile estimated by an infrared sensor, following a laser ignition event.

FIG. 3 shows a high level flow chart of a method for distinguishing a cylinder pre-ignition event from cylinder misfire and knock events based on an in-cylinder temperature profile estimated by an infrared sensor, before a laser ignition event.

FIG. 4 shows example cylinder temperature profiles that may be used to identify and distinguish misfire and pre-ignition events.

### DETAILED DESCRIPTION

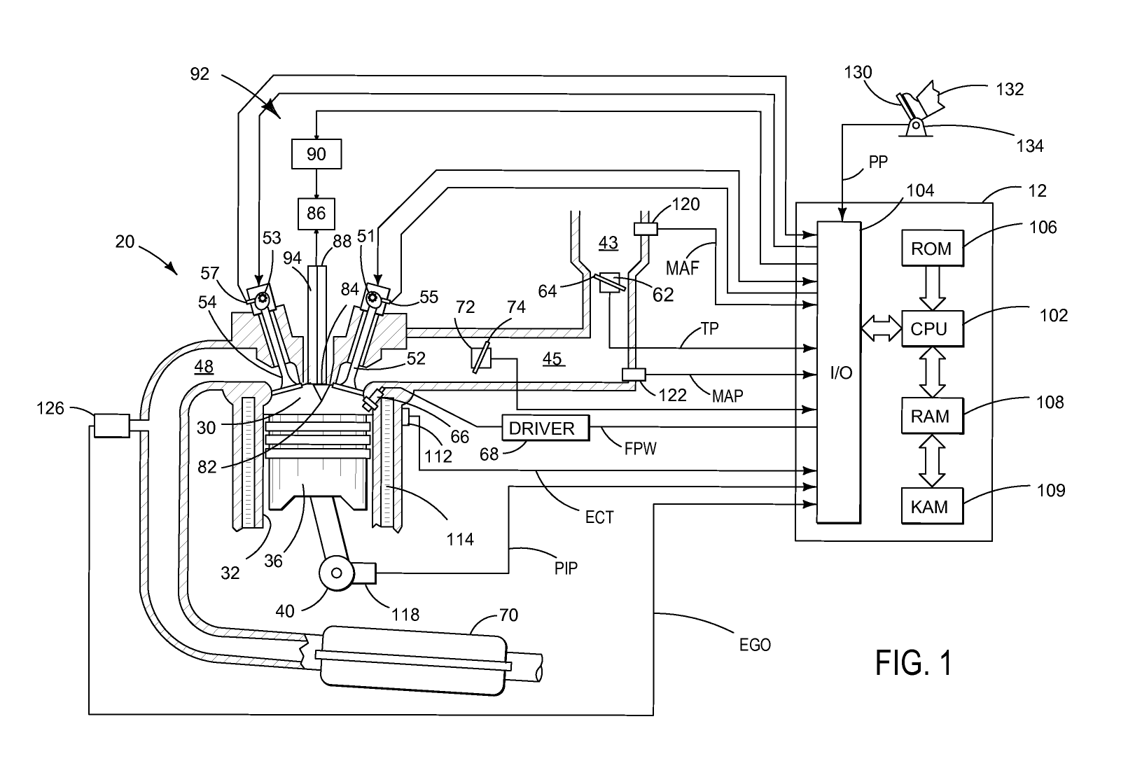

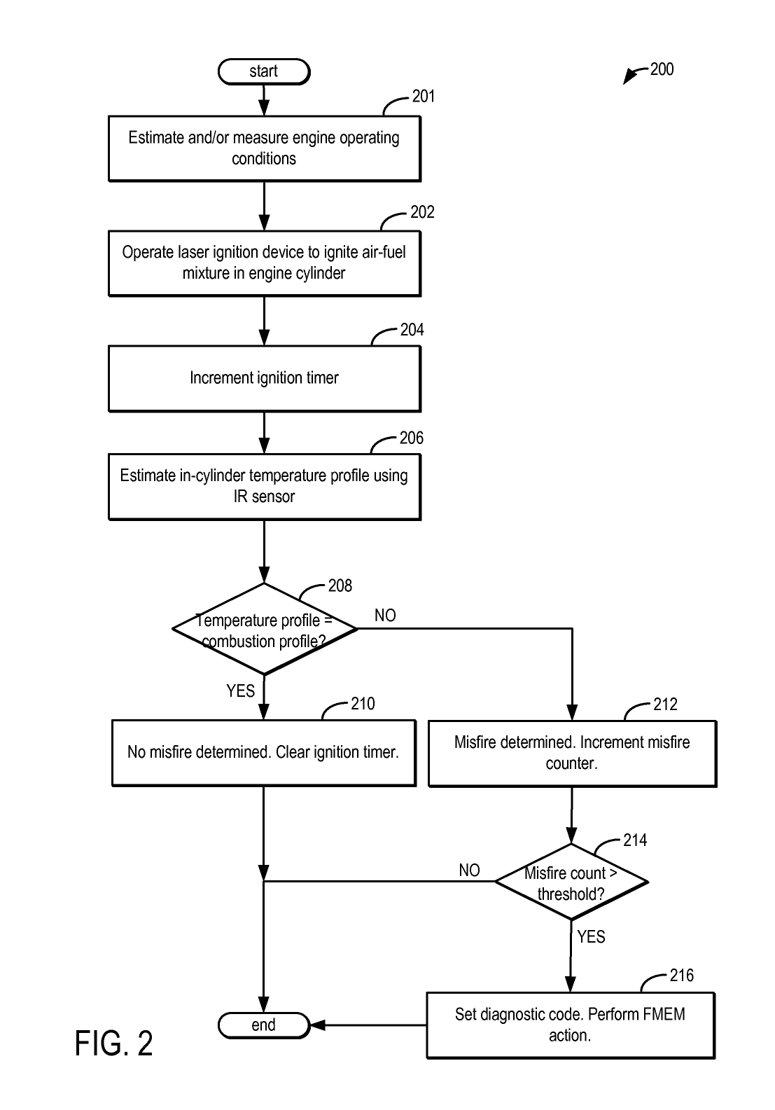

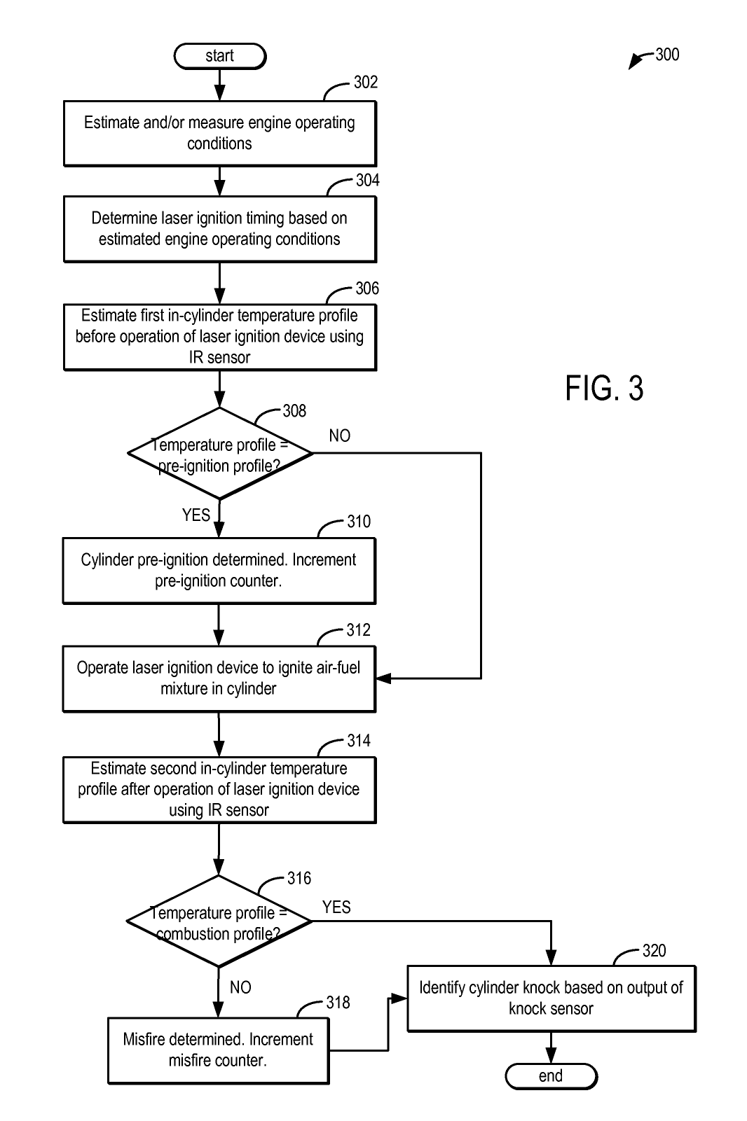

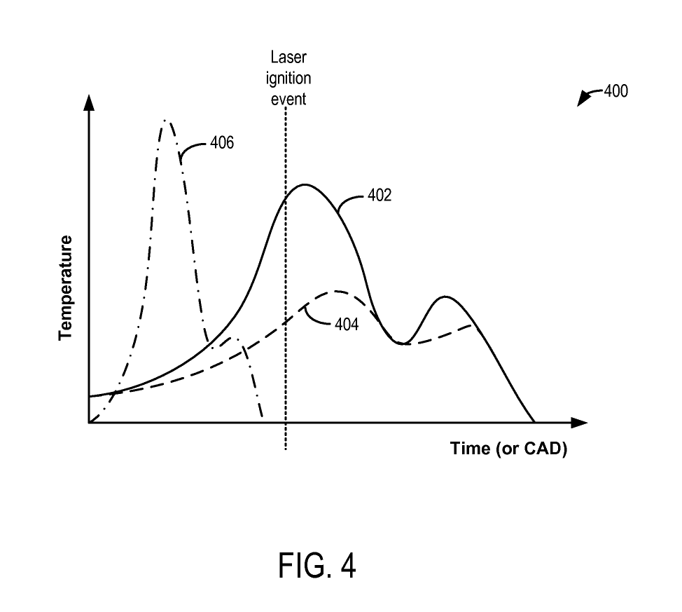

Methods and systems are provided for increasing an accuracy of misfire detection in an engine system configured with laser ignition, as shown in FIG. 1. An engine controller may be configured to perform a control routine, such as the routine of FIG. 2, to identify a misfire event based on an in-cylinder temperature profile following a laser ignition event. The in-cylinder temperature profile may be estimated by an infrared (IR) sensor coupled to the cylinder. The controller may also use an in-cylinder temperature profile estimated immediately before the laser ignition event to identify a cylinder pre-ignition event and differentiate abnormal combustion due to pre-ignition from those due to knock or misfire (FIG. 3). Example temperature profiles that may be used for diagnostics are shown at FIG. 4.

FIG. 1 shows a schematic diagram of an example cylinder of multi-cylinder internal combustion engine 20. Engine 20 may be controlled at least partially by a control system including controller 12 and by input from a vehicle operator 132 via an input device 130. In this example, input device 130 includes an accelerator pedal and a pedal position sensor 134 for generating a proportional pedal position signal PP.

Combustion cylinder 30 of engine 20 may include combustion cylinder walls 32 with piston 36 positioned therein. Piston 36 may be coupled to crankshaft 40 so that reciprocating motion of the piston is translated into rotational motion of the crankshaft. Crankshaft 40 may be coupled to at least one drive wheel of a vehicle via an intermediate transmission system. Combustion cylinder 30 may receive intake air from intake manifold 45 via intake passage 43 and may exhaust combustion gases via exhaust passage 48. Intake manifold 45 and exhaust passage 48 can selectively communicate with combustion cylinder 30 via respective intake valve 52 and exhaust valve 54. In some embodiments, combustion cylinder 30 may include two or more intake valves and/or two or more exhaust valves.

In this example, intake valve 52 and exhaust valve 54 may be controlled by cam actuation via respective cam actuation systems 51 and 53. Cam actuation systems 51 and 53 may each include one or more cams and may utilize one or more of cam profile switching (CPS), variable cam timing (VCT), variable valve timing (VVT) and/or variable valve lift (VVL) systems that may be operated by controller 12 to vary valve operation. To enable detection of cam position, cam actuation systems 51 and 53 should have toothed wheels. The position of intake valve 52 and exhaust valve 54 may be determined by position sensors 55 and 57, respectively. In alternative embodiments, intake valve 52 and/or exhaust valve 54 may be controlled by electric valve actuation. For example, cylinder 30 may alternatively include an intake valve controlled via electric valve actuation and an exhaust valve controlled via cam actuation including CPS and/or VCT systems.

Fuel injector 66 is shown coupled directly to combustion cylinder 30 for injecting fuel directly therein in proportion to the pulse width of signal FPW received from controller 12 via electronic driver 68. In this manner, fuel injector 66 provides what is known as direct injection of fuel into combustion cylinder 30. The fuel injector may be mounted on the side of the combustion cylinder or in the top of the combustion cylinder, for example. Fuel may be delivered to fuel injector 66 by a fuel delivery system (not shown) including a fuel tank, a fuel pump, and a fuel rail. In some embodiments, combustion cylinder 30 may alternatively or additionally include a fuel injector arranged in intake passage 43 in a configuration that provides what is known as port injection of fuel into the intake port upstream of combustion cylinder 30.

Intake passage 43 may include a charge motion control valve (CMCV) 74 and a CMCV plate 72 and may also include a throttle 62 having a throttle plate 64. In this particular example, the position of throttle plate 64 may be varied by controller 12 via a signal provided to an electric motor or actuator included with throttle 62, a configuration that may be referred to as electronic throttle control (ETC). In this manner, throttle 62 may be operated to vary the intake air provided to combustion cylinder 30 among other engine combustion cylinders. Intake passage 43 may include a mass air flow sensor 120 and a manifold air pressure sensor 122 for providing respective signals MAF and MAP to controller 12.

Exhaust gas sensor 126 is shown coupled to exhaust passage 48 upstream of catalytic converter 70. Sensor 126 may be any suitable sensor for providing an indication of exhaust gas air/fuel ratio such as a linear oxygen sensor or UEGO (universal or wide-range exhaust gas oxygen), a two-state oxygen sensor or EGO, a HEGO (heated EGO), a NOₓ, HC, or CO sensor. The exhaust system may include light-off catalysts and underbody catalysts, as well as exhaust manifold, upstream and/or downstream air/fuel ratio sensors. Catalytic converter 70 can include multiple catalyst bricks, in one example. In another example, multiple emission control devices, each with multiple bricks, can be used. Catalytic converter 70 can be a three-way type catalyst in one example.

Controller 12 is shown in FIG. 1 as a microcomputer, including microprocessor unit 102, input/output ports 104, an electronic storage medium for executable programs and calibration values shown as read only memory chip 106 in this particular example, random access memory 108, keep alive memory 109, and a data bus. The controller 12 may receive various signals and information from sensors coupled to engine 20, in addition to those signals previously discussed, including measurement of inducted mass air flow (MAF) from mass air flow sensor 120; engine coolant temperature (ECT) from temperature sensor 112 coupled to cooling sleeve 114; in some examples, a profile ignition pickup signal (PIP) from Hall effect sensor 118 (or other type) coupled to crankshaft 40 may be optionally included; throttle position (TP) from a throttle position sensor; and absolute manifold pressure signal, MAP, from sensor 122. The Hall effect sensor 118 may optionally be included in engine 20 since it functions in a capacity similar to the engine laser system described herein. Storage medium read-only memory 106 can be programmed with computer readable data representing instructions executable by processor 102 for performing the methods described below as well as variations thereof.

Laser system 92 includes a laser exciter 88 and a laser control unit (LCU) 90. LCU 90 causes laser exciter 88 to generate laser energy. LCU 90 may receive operational instructions from controller 12. Laser exciter 88 includes a laser oscillating portion 86 and a light converging portion 84. The light converging portion 84 converges laser light generated by the laser oscillating portion 86 on a laser focal point 82 of combustion cylinder 30.

Laser system 92 is configured to operate in more than one capacity with the timing of each operation based on engine position of a four-stroke combustion cycle. For example, laser energy may be utilized for igniting an air/fuel mixture during a power stroke of the engine, including during engine cranking, engine warm-up operation, and warmed-up engine operation. Fuel injected by fuel injector 66 may form an air/fuel mixture during at least a portion of an intake stroke, where igniting of the air/fuel mixture with laser energy generated by laser exciter 88 commences combustion of the otherwise non-combustible air/fuel mixture and drives piston 36 downward.

LCU 90 may direct laser exciter 88 to focus laser energy at different locations depending on operating conditions. For example, the laser energy may be focused at a first location away from cylinder wall 32 within the interior region of cylinder 30 in order to ignite an air/fuel mixture. In one embodiment, the first location may be near top dead center (TDC) of a power stroke. Further, LCU 90 may direct laser exciter 88 to generate a first plurality of laser pulses directed to the first location, and the first combustion from rest may receive laser energy from laser exciter 88 that is greater than laser energy delivered to the first location for later combustions.

As elaborated herein with reference to FIG. 2, a controller may identify an engine misfire event based on a temperature profile in an engine cylinder following combustion in the cylinder, ignited by the laser ignition device. Further, the controller may identify and distinguish a cylinder pre-ignition event from a misfire or knock event based on a temperature profile of the cylinder before ignition of an air-fuel mixture in the cylinder by the laser ignition device.

Cylinder 30 may further include a sensor for detecting heat and light generated in the cylinder during a combustion event. In the depicted embodiment, the detection sensor is an infra-red (IR) sensor 94. However, in alternate embodiments, detection sensor 94 may be configured as temperature or pressure sensor. The infra-red sensor may be positioned substantially alongside LCU 90. Alternatively, in engines not configured with laser ignition, the IR sensor may be positioned alongside a cylinder spark plug. A lens of the IR sensor 94 may be cleaned prior to sensing via fuel injected onto the surface of the sensor by fuel injector 66. In one embodiment, the IR sensor may be a single sensing element or CCD array to provide information about where the heat originates. Location information about the heat source may be used for identifying hot carbon build-up that may be causing cylinder pre-ignition events and further for directing the laser towards the location to burn off the carbon deposit. As such, hot carbon deposits can form due to excessive cold engine operation, as may occur in plug-in hybrid vehicles.

Controller 12 controls LCU 90 and has non-transitory computer readable storage medium including code to adjust the location of laser energy delivery based on temperature, for example the ECT. Laser energy may be directed at different locations within cylinder 30. Controller 12 may also incorporate additional or alternative sensors for determining the operational mode of engine 20, including additional temperature sensors, pressure sensors, torque sensors as well as sensors that detect engine rotational speed, air amount and fuel injection quantity. Additionally or alternatively, LCU 90 may directly communicate with various sensors, such as temperature sensors for detecting the ECT, for determining the operational mode of engine 20.

As described above, FIG. 1 shows only one cylinder of a multi-cylinder engine, and each cylinder may similarly include its own set of intake/exhaust valves, fuel injector, laser ignition system, etc.

Now turning to FIG. 2, routine 200 depicts a method of identifying a cylinder misfire event based on an in-cylinder temperature profile as estimated by an infra-red (IR sensor). The method enables an air-fuel mixture in an engine cylinder to be ignited with a laser ignition device and a misfire to be indicated based on information received by an infra-red sensor coupled to the cylinder.

At 201, the method includes estimating and/or inferring engine operating conditions. These may include, for example, engine speed, engine temperature, catalyst temperature, boost level, MAP, MAF, ambient conditions (temperature, pressure, humidity, etc.). At 202, the method includes operating the laser ignition device to ignite an air-fuel mixture in an engine cylinder. A timing of laser operation may be determined based on the estimated engine operating conditions. In some embodiments, an intensity of the laser may also be adjusted based on engine operating conditions. At 204, after operating the ignition device, the method includes incrementing an ignition timer. As such, following operating of the laser ignition device, due to ignition of the air-fuel mixture in the cylinder, a cylinder combustion event may occur and a cylinder temperature may be expected to rise. This heat may in turn be sensed by an infra-red sensor.

At 206, an in-cylinder temperature profile may be estimated by the IR sensor. The in-cylinder temperature profile may reflect heat generated in the cylinder and/or released from the cylinder over the course of a cylinder combustion event. For example, the cylinder temperature may be lower during an intake stroke when fresh intake air is received in the cylinder. Then, during a compression stroke, as an air-fuel mixture is compressed, a slight increase in temperature may be observed. Following the laser ignition event, during a compression stroke, ignition of the compressed air-fuel mixture may lead to combustion and a sudden increase in cylinder temperature. Finally, during an exhaust stroke, as the products of combustion are released from the cylinder, a cylinder temperature may fall. Thus, if combustion occurs in the cylinder as expected, a cylinder temperature profile with a peak at or around the compression stroke, at a threshold time since the laser ignition event, may be observed.

At 208, it may be determined if the estimated temperature profile sensed by the cylinder IR sensor matches the expected combustion profile. As such, the expected combustion profile may include an in-cylinder peak temperature that is higher than a threshold temperature. Further, the expected combustion profile may include a peak temperature that occurs at a timing that is after a threshold duration since the operation of the laser ignition device. However, in the event of a misfire event, incomplete combustion may occur. As a result, an amount of heat generated in the cylinder may be substantially lower. Thus, the peak in-cylinder temperature may be lower than the threshold temperature. Further, a timing of the peak temperature in the temperature profile may lie outside of (e.g., later than) the threshold duration since the operation of the laser ignition device.

Thus at 210, if the estimated temperature profile matches the expected combustion profile, no misfire may be determined and the ignition timer may be cleared. In particular, the routine includes indicating a misfire based on a cylinder temperature profile following the laser ignition of the air-fuel mixture and in the same cycle as the laser ignition, wherein the cylinder temperature profile is estimated by the infra-red sensor.

In comparison, if the estimated profile does not match the expected combustion profile, then at 212, a cylinder misfire event may be determined. As elaborated above, the routine includes indicating a misfire if a peak temperature of the cylinder temperature profile occurs outside a threshold duration since the operating of the laser ignition device. The threshold duration may include a duration measured in seconds or crank angle degrees. As another example, the routine may include indicating a misfire in response to a peak in-cylinder temperature of the cylinder temperature profile being lower than a threshold temperature. In both cases, it may be indicated that the misfire was generated by the laser ignition of the air-fuel mixture. By identifying a misfire based on an in-cylinder temperature profile, a misfire event may be identified as it occurs, rather than based on its effects after it has occurred. This enables early detection of misfires, and correspondingly allows mitigating steps to be taken rapidly.

Also at 212, in response to the indication of misfire, a misfire counter may be incremented. In one example, the misfire counter may be included in the controller's memory and may reflect a number of cylinder misfire events that have occurred.

At 214, it may be determined if a misfire count of the misfire counter is higher than a threshold number. That is, it may be determined if a threshold number of cylinder misfire events have occurred. In one example, it may be determined if a threshold number of cylinder misfire events have occurred over a duration or distance of vehicle travel, or over a given drive cycle. If the threshold count has been exceeded, then at 216, a diagnostic code may be set and a mitigating action may be performed. For example, in response to occurrence of a threshold number of cylinder misfire events, the engine may be operated in an FMEM mode. Therein, one or more mitigating actions may be performed including operating the (affected) cylinder richer than stoichiometry (e.g., operating the cylinder rich for a duration), limiting engine airflow (e.g., limiting engine airflow for a duration), reducing an amount of EGR, and increasing a laser ignition power level.

In some embodiments, in response to the indication of a misfire, combustion parameters may be adjusted on a subsequent (e.g., immediately subsequent) cylinder combustion event. These may include, for example, laser ignition parameters. As an example, the indication of misfire may be received during a first cylinder combustion event, and based on the indication of misfire, the controller may adjust a timing of igniting an air-fuel mixture with the laser ignition device during a second, subsequent (e.g., immediately subsequent) cylinder combustion event. The adjusting may include adjusting the ignition timing, or timing of operating the laser ignition device (e.g., advancing towards MBT). In other embodiments, a power level of a subsequent laser ignition event may be adjusted. For example, the power level of the subsequent laser ignition event may be increased so as to better enable complete ignition and combustion of the ignited air-fuel mixture in the cylinder. In still further embodiments, a timing of the laser ignition may be adjusted based on the sensed temperature profile (e.g., based on a location of the peak pressure or temperature) so as to control combustion during a subsequent combustion event.

As yet another example, in response to the indication, fuel injection parameters may be adjusted. For example, the indication of misfire may be received during a first cylinder combustion event, and based on the indication of misfire, the controller may adjust fuel injection to an engine cylinder during a second, subsequent (e.g., immediately subsequent) cylinder combustion event. The adjusting may include advancing the fuel injection and optionally performing more vaporization heating with the laser on a cold engine. In still further embodiments, other combustion parameters may be adjusted responsive to the indication of misfire.

In this way, by monitoring the cylinder temperature profile in a combustion cycle immediately following a laser ignition event in a cylinder, it may be determined that a cylinder misfire event was caused by the laser ignition event. Accordingly, mitigating steps may be taken and a subsequent laser ignition event may be adjusted so as to reduce the likelihood of further misfire events.

Now turning to FIG. 3, routine 300 depicts a method of identifying a cylinder pre-ignition event based on an in-cylinder temperature profile as estimated by an infra-red (IR sensor). The method enables an air-fuel mixture in an engine cylinder to be ignited with a laser ignition device and a cylinder pre-ignition event to be indicated based on information received by an infra-red sensor coupled to the cylinder. The information also enables a cylinder pre-ignition event to be distinguished from a cylinder misfire event or cylinder knock. Further, an operating condition may be adjusted responsive to the indication of pre-ignition.

At 302, the method includes estimating and/or inferring engine operating conditions. These may include, for example, engine speed, engine temperature, catalyst temperature, boost level, MAP, MAF, ambient conditions (temperature, pressure, humidity, etc.). At 304, the method includes determining a timing of laser operation based on the estimated engine operating conditions. In some embodiments, an intensity of the laser ignition may also be adjusted based on engine operating conditions.

At 306, before operating the laser ignition device, a first in-cylinder temperature profile may be estimated immediately preceding the laser ignition of the air-fuel mixture. The cylinder temperature profile may be estimated by an infra-red sensor coupled to the cylinder. As previously elaborated, during a normal combustion event, a normal cylinder combustion temperature profile may be observed that includes a peak temperature that above a threshold and at a threshold timing since a laser ignition event. However, during selected engine operating conditions, a low speed pre-ignition event can occur even before ignition has occurred. Such pre-ignition events may have characteristically elevated cylinder temperatures and pressures that are can degrade engine performance and life.

At 308, it may be determined if the estimated temperature profile matches a pre-ignition profile. For example, it may be determined whether a peak temperature of the first in-cylinder temperature profile is higher than a threshold temperature and occurs more than a threshold duration before (an estimated timing of) the laser ignition. The threshold duration may include a duration measured in seconds or crank angle degrees. If yes, then at 310, a cylinder pre-ignition event may be confirmed. Further, an engine pre-ignition counter may be incremented.

If pre-ignition is confirmed, the controller may adjust an operating condition responsive to an indication of pre-ignition. Adjusting an operating condition may include adjusting one or more of a laser ignition timing and a cylinder fuel injection based on the indication. For example, in response to the indication of pre-ignition, the pre-ignition affected cylinder may be temporarily enriched (or enleaned). As another example, a timing of laser ignition in the affected may be retarded farther from MBT, injector timing may be retarded, and/or engine load may be reduced.

If the temperature profile sensed by the IR sensor does not match the pre-ignition profile, the routine proceeds to 312. In addition, after indicating pre-ignition, the routine proceeds to 312. At 312, the routine includes igniting an air-fuel mixture with the laser ignition device in an engine cylinder. That is, the laser ignition device may be operated according to the settings (power, timing, etc.) previously determined at 304.

At 314, following operation of the laser ignition device, a second in-cylinder temperature profile estimated by the infra-red sensor immediately following the laser ignition of the air-fuel mixture. As such, it will be appreciated that the first in-cylinder temperature profile is estimated immediately preceding the laser ignition of the air-fuel mixture, and in the same cycle as the laser ignition, while the second the cylinder temperature profile is estimated immediately following the laser ignition of the air-fuel mixture, and in the same cycle as the laser ignition. Further, each of the first and second temperature profiles are estimated by the infra-red sensor.

At 316, the second in-cylinder temperature profile may be compared to an expected combustion profile, as previously explained with reference to FIG. 2. Based on the second in-cylinder temperature profile not matching the expected profile, a cylinder misfire event may be indicated. In particular, at 318, based on a peak temperature of the second in-cylinder temperature profile being higher than a threshold temperature and occurring more than a threshold duration after the laser ignition event, a misfire event may be indicated. In response to the indication of misfire, a misfire counter may be incremented.

From 316 or 318, the routine proceeds to 320 to determine cylinder knock based on output of a knock sensor coupled to an engine block. For example, based on the output of the knock sensor being higher than a threshold and within a threshold crank angle range, cylinder knock may be indicated. In this way, the output of the knock sensor may be used to identify knock while the output of the IR sensor may be used to identify pre-ignition and misfire. Further, cylinder pre-ignition and knock may be accurately distinguished.

As one example, an engine controller may be configured to operate a laser ignition device to ignite an air-fuel mixture in an engine cylinder. The controller may then indicate cylinder knock based on output of a knock sensor coupled to an engine block, while indicating cylinder pre-ignition based on a first cylinder temperature profile immediately preceding the operating of the laser ignition device, and while indicating misfire based on a second cylinder temperature profile immediately following the operating of the laser ignition device. Therein, each of the first and second cylinder temperature profiles may be estimated by an infra-red sensor coupled to the cylinder and may be estimated in the same cycle as the laser ignition event.

It will be appreciated that while the routines of FIGS. 2-3 show the identification of abnormal combustion events (misfire or pre-ignition) based on the output of a cylinder IR sensor, in still other examples, the sensed infra-red information may be used to identify the presence of soot deposits in a cylinder (such as, “hot spots” of soot within the cylinder). Accordingly, based on the identification of hot spots of soot, mitigating actions may be performed. For example, infra-red information sensed by the infra-red sensor (including an in-cylinder temperature profile estimated by the infra-red sensor) during at least an intake stroke and a compression stroke of a cylinder combustion event may be advantageously used to indicate soot deposits in the cylinder. In one embodiment, for detection of the basic presence of a hot spot, a single element IR sensor may be used. In another embodiment, for successful location identification of hot spots, the IR sensor would need to provide direction information, which could be accomplished by using a CCD array. The presence only method may be used for increased cylinder temperature mitigation, while direction information would be needed to do mitigation with the laser directly. An engine controller may be configured to increase a cylinder combustion temperature in response to the infra-red information indicative of soot deposits sensed in the cylinder. As an example, in embodiments where the engine is configured with laser ignition for igniting an air-fuel mixture in the cylinder, increasing combustion temperature may include increasing a power level of the laser ignition. In still another example, in response to the infra-red information indicative of soot deposits, the controller may be configured to temporarily increase an engine load to burn the soot deposits in the cylinder. For example, sustained running at higher RPM at stoichiometry or slightly lean and near MBT may be used for increasing cylinder temperature to burn off soot rapidly. Also, the laser itself can be used to burn off the soot if its location is known.

Now turning to FIG. 4, map 400 depicts example temperature profiles estimated by an IR sensor coupled to an engine cylinder. The example temperature profiles may have been collected during the same cycle as a laser ignition event in the cylinder. The different temperature profiles are shown with reference to the timing of a laser ignition event (dotted line). In particular, plot 402 (solid line) shows a cylinder temperature profile for a normal cylinder combustion event, plot 404 (dashed line) shows a cylinder temperature profile for a cylinder misfire event while plot 406 (dashed and dotted line) shows a cylinder temperature profile for a cylinder pre-ignition event.

As such, the in-cylinder temperature profile reflects heat generated (during combustion) in the cylinder during a cylinder combustion event. Thus, during a normal combustion event, as shown at plot 402, the cylinder temperature may gradually increase during an intake stroke and into a compression stroke until a peak in-cylinder temperature is reached during a power stroke, soon after the air-fuel mixture is ignited in the cylinder by the laser ignition event. Then, as the cylinder progresses into the exhaust stroke, the temperature may fall due to release of combustion products from the cylinder.

In the event of a misfire, incomplete combustion may occur. Consequently, peak cylinder temperatures achieved may not be as high as those achieved during normal combustion. This is reflected at plot 404 wherein a peak in-cylinder temperature following the laser ignition event is substantially lower than the peak in-cylinder temperature achieved in plot 402. Further, due to the incomplete nature of the combustion, the peak temperature may occur later in the combustion cycle. As can be seen by comparing the peak of plots 402 and 404, in the event of a misfire (plot 404), the peak temperature occurs after a longer duration (or after a greater number of crank angles degrees) since the laser ignition event. Thus, by comparing an expected combustion profile (plot 402) with an estimated combustion profile (plot 404) during a combustion cycle, a cylinder misfire event triggered by the laser ignition event can be rapidly identified and addressed.

In the event of pre-ignition, combustion occurs earlier than expected, and autonomously. That is, the pre-ignition event may occur even before an ignition event is performed. Further, combustion temperatures achieved during pre-ignition may be substantially higher than those achieved during normal combustion. This is reflected at plot 406 wherein a peak in-cylinder temperature is achieved earlier in the combustion cycle (in particular, before the laser ignition event) and is substantially higher than the peak in-cylinder temperature achieved in plot 402. As can be seen by comparing the peak of plots 402 and 406, in the event of pre-ignition (plot 406), the peak temperature occurs at a duration earlier than (or a number of crank angles degrees earlier than) the laser ignition event. Thus, by comparing an expected combustion profile (plot 402) with an estimated combustion profile (plot 406) during a combustion cycle, a cylinder pre-ignition event preceding the laser ignition event can be rapidly identified and correspondingly addressed.

In a further representation, a method, comprises: operating a laser ignition device to ignite an air-fuel mixture in an engine cylinder; indicating cylinder knock based on output of a knock sensor coupled to an engine block; indicating cylinder pre-ignition based on a first cylinder temperature profile immediately preceding the operating of the laser ignition device; and indicating misfire based on a second cylinder temperature profile immediately following the operating of the laser ignition device, wherein each of the first and second cylinder temperature profiles are estimated by an infra-red sensor coupled to the cylinder.

In this way, based on correlations between an in-cylinder temperature profile sensed by an infra-red sensor and estimated around a laser ignition event, abnormal combustion events may be identified. By correlating significantly lower (and later) cylinder heat generation following a laser ignition event with the occurrence of a misfire, a cylinder misfire event can be identified as soon as it occurs, and may be rapidly addressed. Likewise, by correlating significantly higher (and earlier) cylinder heat generation preceding a laser ignition event with the occurrence of pre-ignition, a cylinder pre-ignition event can be identified as soon as it occurs, and may be rapidly addressed. By improving the accuracy and reliability of misfire detection, and differentiation of misfire events from other abnormal combustion events, engine performance may be improved.

It will be appreciated that the configurations and methods disclosed herein are exemplary in nature, and that these specific embodiments are not to be considered in a limiting sense, because numerous variations are possible. For example, the above technology can be applied to V-6, I-4, I-6, V-12, opposed 4, and other engine types. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method, comprising:
operating a laser ignition device of an engine cylinder to ignite an air-fuel mixture in the cylinder;
generating a cylinder temperature profile over a combustion event of the cylinder via an infra-red sensor; and
indicating a cylinder misfire event based on the generated cylinder temperature profile.

2. The method of claim 1, wherein indicating a misfire based on an infra-red sensor includes indicating a misfire based on a cylinder temperature profile following the laser ignition of the air-fuel mixture and in the same cycle as the laser ignition, the cylinder temperature profile estimated by the infra-red sensor.

3. The method of claim 2, wherein the indicating includes indicating a misfire if a peak temperature of the cylinder temperature profile occurs outside a threshold duration since the operating of the laser ignition device.

4. The method of claim 2, wherein the indicating includes indicating a misfire in response to a peak in-cylinder temperature of the cylinder temperature profile being lower than a threshold temperature.

5. The method of claim 1, wherein indicating a misfire includes indicating that the misfire was generated by the laser ignition of the air-fuel mixture.

6. The method of claim 1, further comprising, in response to occurrence of a threshold number of cylinder misfire events, setting a diagnostic code and performing a mitigating action including one or more of operating the cylinder richer than stoichiometry, limiting engine airflow, reducing an amount of EGR, and increasing a laser ignition power level.

7. The method of claim 1, wherein the indicating is during a first cylinder combustion event, the method further comprising, adjusting a timing of igniting air-fuel mixture with the laser ignition device during a second, subsequent cylinder combustion event based on the indication of misfire.

8. The method of claim 7, wherein the adjusting includes advancing or retarding the timing towards MBT.

9. The method of claim 1, wherein the indicating is during a first cylinder combustion event, the method further comprising, adjusting fuel injection to an engine cylinder during a second, subsequent cylinder combustion event based on the indication of misfire.

10. The method of claim 9, wherein the adjusting includes advancing or retarding the fuel injection towards MBT.

11. A method, comprising:
igniting air-fuel mixture with a laser ignition device in an engine cylinder; and
adjusting an operating condition responsive to an indication of pre-ignition, the indication of pre-ignition based on an infra-red sensor.

12. The method of claim 11, wherein the indication of pre-ignition based on an infra-red sensor includes indicating pre-ignition based on an in-cylinder temperature profile estimated immediately preceding the laser ignition of the air-fuel mixture, and in the same cycle as the laser ignition, the cylinder temperature profile estimated by the infra-red sensor.

13. The method of claim 12, wherein the indicating includes indicating pre-ignition if a peak temperature of the in-cylinder temperature profile is higher than a threshold temperature and occurs more than a threshold duration before the laser ignition.

14. The method of claim 11, wherein adjusting an operating condition includes, adjusting one or more of a laser ignition timing and a cylinder fuel injection based on the indication.

15. The method of claim 13, wherein the in-cylinder temperature profile estimated immediately preceding the laser ignition of the air-fuel mixture is a first temperature profile, the method further comprising, indicating misfire based on a second in-cylinder temperature profile estimated by the infra-red sensor immediately following the laser ignition of the air-fuel mixture, and in the same cycle as the laser ignition.

16. The method of claim 15, further comprising, indicating cylinder knock based on output of a knock sensor coupled to an engine block.

17. A method for an engine, comprising:
increasing combustion temperature in response to infra-red information sensed in a cylinder, the infra-red information indicative of soot deposits.

18. The method of claim 17, wherein the engine is configured with laser ignition for igniting an air-fuel mixture in the cylinder, and wherein increasing combustion temperature includes increasing a power level of the laser ignition and directing the laser towards the soot deposit at least during expansion and exhaust strokes.

19. The method of claim 18, wherein infra-red information sensed in the cylinder includes an in-cylinder temperature profile estimated by an infra-red sensor during at least an intake and a compression stroke of a cylinder combustion event.

20. The method of claim 19, further comprising, in response to the infra-red information indicative of soot deposits, temporarily increasing an engine load to burn the soot deposits.
